(19) United States
(12) Patent Application Publication
(10) Pub. No.: US 2006/0011111 A1
(43) Pub. Date: Jan. 19, 2006

(54) Safe with low-voltage power system

(75) Inventors: Ken Stoddard, Santaquin, UT (US); Darren Wall, Payson, UT (US); Mike Jennings, Lindon, UT (US)

Correspondence Address: THORPE NORTH & WESTERN, LLP., 8180 SOUTH 700 EAST, SUITE 200, SANDY, UT, 84070, US

(73) Assignee: Liberty Safe and Security Products, Inc.

(21) Appl. No.: 10/895,263

(22) Filed: Jul. 19, 2004

(51) Int. Cl. E05G 1/00

(52) U.S. Cl. 109/1 R

(57) ABSTRACT

A safe with an integrated low voltage power system includes a transformer and a power distribution system, disposed within the safe. The transformer is configured to convert AC power input to low voltage DC power, and the power distribution system is configured to distribute the low voltage power to DC devices inside the safe. The DC devices can include lights, a safe locking mechanism, alarm devices, sensors, a clock, and a dehumidifying system, such as a heater, a cooler, or an electro-resistively heated rack. The cooler can be a thermo-electric device, configured to cause condensation on a cold plate, and including a drain, configured to direct the condensation to a point outside the safe.

### BACKGROUND OF THE INVENTION

1. Field of the Invention

The present invention relates generally to safes. More particularly, the present invention relates to an internal low-voltage power system for a safe.

2. Related Art

Home and gun safes are gradually becoming more popular and desirable. While high security metal safes are very secure, they tend to be very expensive and very heavy, and are not generally suitable for a typical consumer. On the other hand, lower cost safes have almost become a new household appliance. These safes are typically fabricated of thinner steel than high security safes (i.e. sheet steel, rather than steel plates), and are intended to provide moderate security. However, they provide high fire protection, which is generally more important for a home safe. The interior of such safes may include gun racks, shelves, file drawers, and other storage systems for holding various types of valuables such as guns, cash, coins, jewels, stocks, bonds, important documents, records, electronic storage media (e.g. videotapes, floppy disks, compact disks, etc.), and so forth. Gun safes of this type have also become popular in recent years in view of some widely publicized incidents related to unsecure storage of firearms.

For convenience, a variety of electrical devices and features are often included in home safes. For example, it is desirable to include interior lighting in a safe, in order to allow a user to view and sort the contents of the safe. Some safes also include electric locks, alarm systems, alarm indicator lights, timer clocks, etc. Additionally, it is also desirable to control the interior environment of a safe in order to improve conditions for the preservation of items in the safe, such as metal, paper, etc. For this purpose, many safes include electric heaters, etc. to help control temperature and humidity in the safe.

In order to provide electrical power for these devices, many safes have an electrical power cord that extends through the back wall of the safe. The power cord is configured to connect to an electric outlet for obtaining common household AC current. Inside the safe, the power cord is connected to a power strip, with sockets into which other electric devices can be plugged. Additionally, it will be apparent that some of the above-mentioned electrical devices run on DC power. For example, timer clocks, alarms, even interior lights that use lower voltage DC power, rather than 110 volts AC, may be more desirable for use in a safe. Accordingly, each DC device can include its own transformer for converting AC to DC, with a power cord that plugs into the power strip. Alternatively, assuming all the DC devices have the same voltage requirements, the safe can include a single transformer that plugs into the AC power strip, and converts the higher voltage AC current into lower voltage DC power for the safe interior devices. A power distribution device for connecting each of the DC devices to the transformer will also be required to distribute power.

Unfortunately, either of these approaches tends to result in a sort of cluttered hodge-podge of devices inside a safe. If each DC device includes its own transformer, this will increase the bulk of these devices, and the separate power cords must all be routed to the power strip. Even if only one transformer is provided, the interior of the safe will include the various electrical devices, the power strip, the transformer, the power distribution device, and the cords associated with each device.

Additionally, because of the typical power supply system, the electric heater in many lower cost home safes is frequently a device configured to operate on 110 volt AC power. While such devices are readily available, they tend to be expensive, bulky, and consume more power than is really needed for the purpose they serve.

### SUMMARY OF THE INVENTION

It has been recognized that it would be advantageous to develop an integrated, low voltage DC power distribution system for a safe.

It has also been recognized that it would be advantageous to develop a safe with a low voltage dehumidifying system that is simple, effective, and low cost.

The invention advantageously provides a safe with an integrated power system, including a transformer, associated with the safe, configured to convert AC power input to low voltage DC power. A power distribution system is disposed within the safe, and configured to distribute low voltage power from the transformer to DC powered devices inside the safe.

In accordance with a more detailed aspect of the present invention, the DC powered devices inside the safe can be selected from the group consisting of lights, a dehumidifying system, a safe locking mechanism, alarm devices, sensors, and a clock.

In accordance with another more detailed aspect thereof, the dehumidifying system can be selected from the group consisting of a heater, a cooler, and an electro-resistively heated rack. In one embodiment, the cooler is a thermoelectric device, configured to transfer heat between two conductive plates and cause one conductive plate to become cold, thereby causing water vapor in the air within the safe to condense on the cold plate, and further including a drain, configured to direct condensation from the cooler to a point outside the safe.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of the exterior of a typical low cost home safe having a low-voltage power system in accordance with the present invention.

FIG. 2 is a side, cross-sectional view of a safe having a low-voltage power system in accordance with the present invention.

FIG. 3 is a side, cross-sectional view of an alternative embodiment of a safe in accordance with the present invention, incorporating a different variety of low-voltage devices, and wherein the dehumidifying device comprises a thermoelectric cooler.

FIG. 4 is a close-up side, cross-sectional view of one embodiment of a thermo-electric cooler installed in a manner similar to that of the embodiment of FIG. 3.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

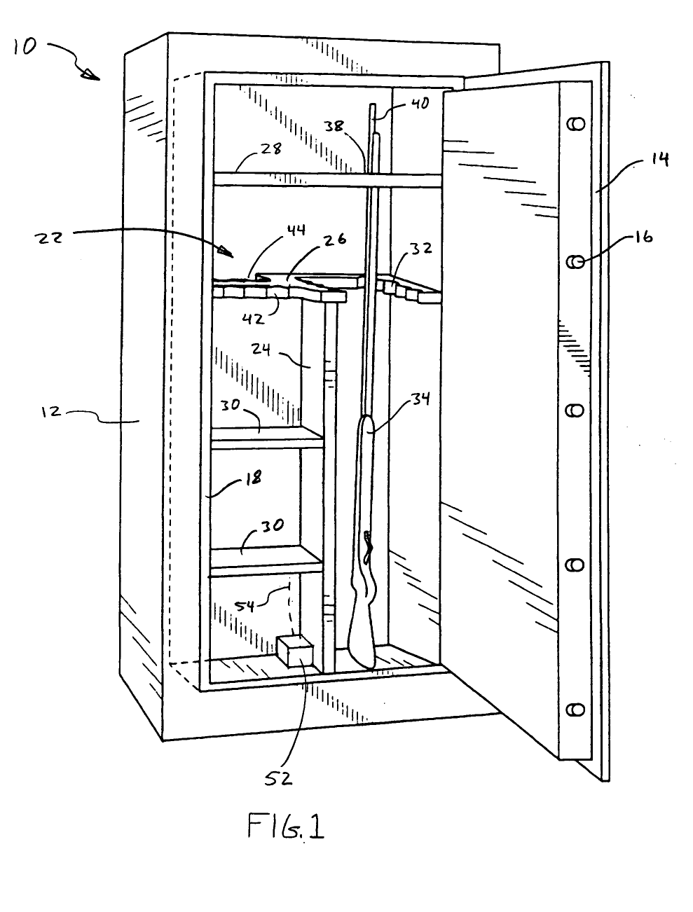

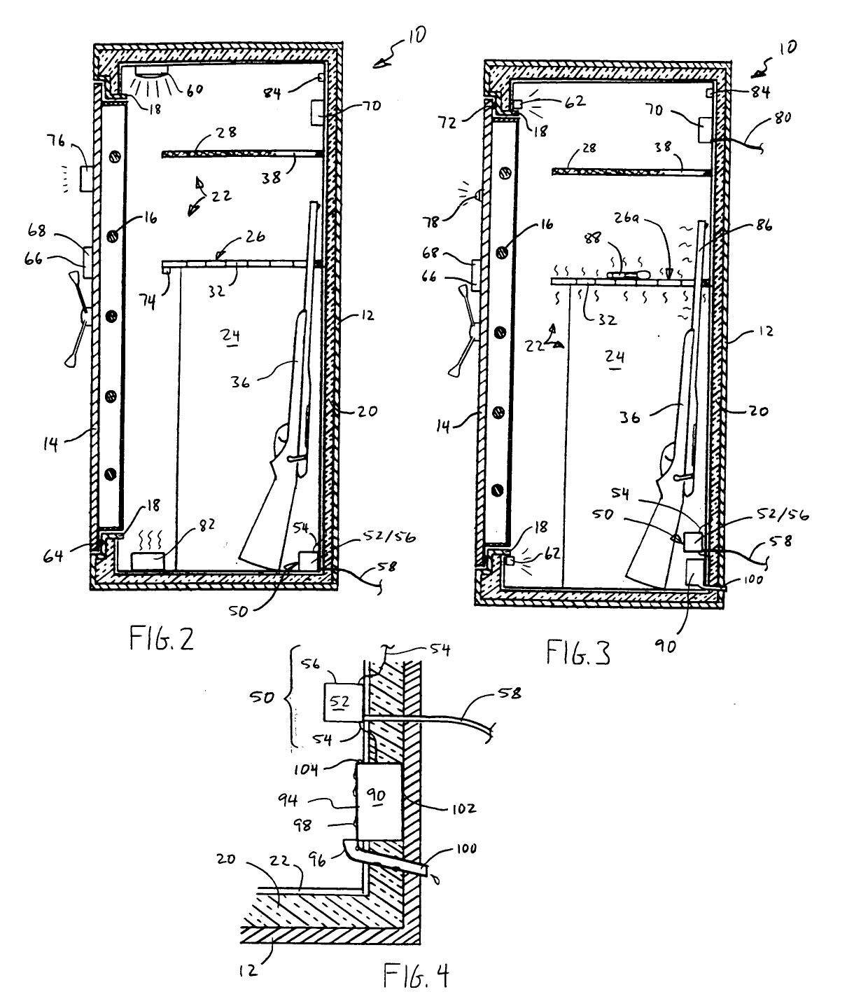

The present invention relates to metal safes, particularly lower cost home and gun safes. Such a safe 10 is depicted pictorially in FIG. 1, and in cross-section in FIGS. 2 and 3. The safe generally comprises a steel body or case 12 with a hinged door 14 that when closed is locked with a series of hardened steel door bolts 16 that extend into or behind the safe door jamb 18. It will be apparent that a locking mechanism for locking the bolts (not shown) will be included, typically located within the safe door. As shown in FIGS. 2 and 3, the safe includes a substantial thickness of fire-proofing insulation 20 disposed inside the steel case, in order to protect the contents of the safe from fire damage. It will be apparent that fire insulation will also be included within the safe door, though this is not shown in the cross-sectional views of FIGS. 2 and 3. Additionally, these types of safes also typically include a resilient and fire resistant door seal material between the door and the door jamb, though this element is also not shown in the figures.

The interior of the safe 10 includes an interior structure 22 disposed inside of the insulation 20. The interior structure can include shelves, racks (e.g. gun racks), dividers, file drawers, and other storage systems for holding various types of items. For example, the safe shown in FIG. 1 includes an interior structure comprising a vertical divider 24 that supports a rack 26 at a central location within the safe. The vertical divider and the rack are relatively permanently installed in the safe by means of dowel pins, nails, screws, etc. An additional upper shelf 28 is disposed above the reconfigurable rack, and additional lower shelves 30 are disposed on one side of the vertical divider. It will be apparent that the additional shelves in the safe can be configured to be removable, allowing the interior structure to be further reconfigurable. The interior structure, including the divider, rack, and shelves, can be formed of any suitable material, such as wood, particle board, etc., and can be covered with fabric such as carpet, velour or similar fabric. The fabric provides a surface which has a relatively high coefficient of friction and an aesthetically pleasing, neat, clean, and easily maintainable appearance.

The rack 26 includes a first cutout portion 32 with an undulating shape that is configured to receive long narrow articles, such as guns, archer's bows, fishing rods, etc. In FIG. 1 a musket 34 is shown, received in the first cut-out portion of the rack. In FIGS. 2 and 3, a rifle 36 is shown received in the first cutout portion. The upper shelf 28 can also include a cut-out portion 38 that is aligned with a portion of the first cutout portion, to allow the passage of particularly long objects through the shelf. For example, as shown in FIG. 1, the long barrel 40 of the musket extends through the cutout portion in the upper shelf. Further cut-out portions 42, 44 can also be provided in the rack 26 to accommodate additional long narrow articles, such as additional firearms, fishing poles, hunting bows, etc. Like the first cut-out portion, these additional cut-out portions can have an undulating configuration, adapted to receive and support long narrow articles in a vertical orientation.

Advantageously, the interior structure 22 can be reconfigurable in various ways to allow greater flexibility of use and configuration. For example, the rack 26 and any shelves with cutout portions can be provided with removable cover plates (not shown) configured for covering the cutout portions to give the rack and/or the shelves the appearance and function of a continuous shelf. Such a reconfigurable interior structure for a safe is disclosed in U.S. Pat. No. 6,042,207, the disclosure of which is incorporated herein by reference in its entirety. In another aspect, the interior structure can be reconfigurable by means of removable shelves. Specifically, the upper shelf 28 and lower shelves 30 can be supported by removable shelf support clips (not shown). This feature allows these shelves to be removed if desired to allow additional long or bulky articles to be stored in the safe 10, if needed.

As noted above, it is desirable to include a variety of electric devices inside a safe, such as interior lighting, electric locks, alarm systems, alarm indicator lights, timer clocks, etc. Additionally, it is also desirable to control the interior environment of a safe in order to improve conditions for the preservation of items in the safe, such as metal, paper, etc. For this purpose, many safes include electric heaters, etc. to help control temperature and humidity in the safe.

The present invention advantageously provides a safe 10 configured with an integrated low voltage power system 50. Viewing FIGS. 2 and 3, the integrated low voltage power system generally comprises a transformer/power distribution device 52 that converts 110-volt AC power input to low voltage DC power (e.g. 12 volt), and distributes the low voltage power through power distribution wires 54 to various devices inside the safe. As shown in FIG. 1, the transformer/power distribution device can be unobtrusively placed in an out-of-the-way location within the safe, and the power distribution wires can be hidden within or behind the walls of the interior structure 22 of the safe. It will be apparent, however, that the transformer/power distribution device could also be disposed outside the safe, with wires extending into the safe.

As shown in FIGS. 2 and 3, the transformer/power distribution device 52 is preferably disposed within a single compact housing 56, making the system very unobtrusive and conservative of space. A transformer/power distribution device that is readily commercially available and is compatible with the present invention is the Plug-In Transformer available from Seagull Lighting of Riverside, N.J. A power supply cord 58 extends from the transformer/power distribution device, through the wall of the interior structure 22, through the fire insulation material 20, through the metal safe wall 12, and to an AC power source (not shown), such as a typical household electrical outlet. The power distribution wires that extend from the transformer/power distribution device to the various low voltage devices can be disposed between the wall of the safe interior structure and the fire insulation material, so as to protect the wires and provide a pleasing appearance.

The low voltage DC power can be used for a wide variety of devices. While certain combinations of low voltage devices are shown in FIGS. 2 and 3, it will be apparent that the invention is not limited to the particular combinations and types of devices shown. Different combinations of the devices shown, as well as other low voltage devices not shown, can be incorporated into a safe with a low voltage power system in accordance with the present invention. Additionally, it will be apparent that DC power distribution wires 54 will be required to extend to the various DC devices in the safe, though these are generally not shown.

As shown in FIG. 2, the safe can include lights, such as a single overhead lamp 60. Alternatively, as shown in FIG. 3, the safe can include a light strip 62, comprising a series of very small incandescent bulbs disposed in a long clear polymer tube, disposed around the perimeter of the safe door jamb 18. A suitable light strip that is readily commercially available and compatible with the present invention is the LX Lighting System available from Seagull Lighting. Light strips are very popular because they provide a more uniform level of light to all regions of the inside of the safe 10, but consume a relatively small amount of power. The safe can also include a door contact switch 64, shown in FIG. 2, that automatically turns the light on when the safe is opened, and turns the light off when the safe door 14 is closed.

Other desirable DC devices can also be included in the safe. For example, the safe can include an electric locking mechanism 66, shown attached to the safe door 14 in FIG. 2, that draws power from the power distribution system 50. The electric locking mechanism can also include a clock 68 within a common housing. This can allow the safe 10 to include a time lock feature for additional security. Additionally, an electronic alarm system 70 (shown in both FIGS. 2 and 3) can be disposed within the safe and draw power from the DC power distribution system 50. The alarm system can be interconnected to a variety of sensors that are configured to trigger an alarm. Such sensors can include a magnetic door sensor (72 in FIG. 3) for detection of opening of the safe door 14, a motion sensor (74 in FIG. 2), etc. The alarm system can be a purely local alarm that provides a security warning from the safe itself. For example, the safe embodiment in FIG. 2 includes a sound transducer 76 (e.g. a siren) for providing a loud audible signal in case of a break-in or other irregular condition that is detected. Alternatively, the alarm system can be associated with an indicator light 78 (shown in FIG. 3) that illuminates if there has been a security breach.

As an alternative to a purely local security or alarm system, the alarm system 70 can include a communications link 80 (e.g. a telephone line) extending outside of the safe 10 for interconnection with a remote security system, such as a professionally monitored security service, similar to home alarm security systems. This sort of alarm system can provide a remote alarm if the security of the safe is compromised in some way. It will be apparent that the clock or timer 68 can be interconnected with either or both the safe locking mechanism 66 and the security alarm system 70.

The low voltage DC power distribution system 50 can also include a temperature control/dehumidifying system. This system can be configured in a variety of ways. It is well known that providing an electric heater inside a safe will both heat the air in the safe and naturally dehumidify it. Accordingly, in the embodiment of the invention shown in FIG. 2, the temperature control/dehumidifying system comprises a DC powered electric heater 82. This heater includes electro-resistive heating elements which, upon the application of sufficient electric current, heat up and transmit this heat to the surrounding air and nearby objects. The increased temperature in the safe naturally drives more ambient moisture into vapor form, rather than allowing it to remain as condensation or surface moisture that can damage items in the safe. A 12 volt DC heater that is readily commercially available and is compatible with the present invention is the Eliminator 12V, available from Online Warehouse of Springville, Utah. The inventors have found that for a safe having a volume of 23 cu. ft., this particular heater will typically consume from about 5 to 15 watts to maintain a temperature differential of 1-5° F. between the interior and exterior of the safe.

The electric heater 82 can be associated with a sensor or thermostat 84 that is interconnected to controls for the heater, so as to cause the heater to cycle on and off as needed to maintain a desired temperature. Additionally or alternatively, the sensor/thermostat can include a humidity sensor that controls or assists with control of the heater, allowing the heater to operate as needed to maintain the relative humidity in the safe at a desired level.

As an alternative or additional heating system, the safe can include an electro-resistively heated rack. Such a system is depicted in FIG. 3. As shown in this figure, the rack 26a includes electro-resistive heating coils, and heats objects that are in contact with it so as to inhibit condensation on the items. These items are heated by the rack, and also transfer heat to the air in the safe, thus allowing the heated rack and the items in contact with it to heat the entire safe. A suitable electro-resistive heating coil product that is readily commercially available and is compatible with the rack of present invention is the STEP Heating Element available from Electroplastics Corp. of St. Louis, Mo.

As shown in FIG. 3, the barrel 86 of the rifle 36 and a handgun 88 are in direct contact with the heated rack 26a. By heating the gun rack and transferring the heat to the guns, the guns are protected from condensation, which in turn reduces oxidation. Additionally, the heated guns (or other items in contact with the heated rack) radiate heat to the surrounding air and other objects in the safe, thus raising the temperature and lowering the relative humidity in the safe for all its contents.

The heated rack 26a can be configured to heat items in contact therewith to a point above the surrounding ambient air temperature. The heated rack can also be configured to heat the air and contents of the safe to a point above the dewpoint of the surrounding ambient air, so as to reduce or eliminate condensation on items stored in the safe. The thermostat/humidity sensor 84 can be provided in the safe as discussed above to assist in controlling the heated rack system to substantially maintain a desired temperature and/or humidity level in the safe. In one embodiment, the electro-resistively heated rack is configured to conductively heat the objects in contact with it such that they will not be the coldest surface inside the safe, thereby causing any condensation to form elsewhere. The inventors have found that for a safe having a volume of 23 cu. ft., a suitable electro-resistively heated rack will typically consume from about 5 to 15 watts to maintain a temperature differential of 1-5° F. between the interior and exterior of the safe.

Another aspect or embodiment of a temperature control/dehumidifying system suitable for use with the safe of the present invention is depicted in FIGS. 3 and 4. In this embodiment, the temperature control/dehumidifying device comprises a DC powered thermo-electric cooler 90 (TEC). The TEC is a solid state electronic device that uses the Peltier effect to transfer heat between two thermally conductive plates, causing one plate to become warm and the other cold. Water vapor in the air in the safe will naturally condense on the cold plate of the TEC, thus allowing the TEC to operate as a dehumidifier to controllably promote condensation so as to draw water vapor from surrounding ambient air within the safe. This will reduce the humidity level in the safe and reduce water damage to guns or other objects stored in the safe. However, given the nature of its operation, and that the cold and hot plates are both disposed within the safe, the TEC has substantially no net effect on the interior temperature of the safe.

Shown in FIG. 4 is a close-up side, cross-sectional view of a thermo-electric cooler 90 installed slightly differently than the embodiment of FIG. 3. In the embodiment of FIG. 3, the TEC is attached to the inside interior structure 22 and insulation 20 of the safe. In the embodiment of FIG. 4, the TEC is installed with its hot plate 102 against the metal back wall 12 of the safe, with the cold plate 94 exposed toward the inside of the safe so that ambient air in the safe can come readily into contact with the cold plate. Water vapor will naturally condense on the cold plate, and this condensation 98 is collected in a trough 96 at the bottom of the cold plate, and channeled out of the safe through a drain 100.

As with the other heating/cooling devices discussed above, the TEC 90 can have its own thermostat/humidity sensor 104, or be interconnected to a separate thermostat/humidity sensor (84 in FIG. 3), so as to allow the device to operate to maintain desired levels for these environmental parameters. One thermo-electric cooler that is commercially available and compatible with the present invention is item INBC1-127-08S available from LXO Industries of Van Nuys, Calif. In a safe stored in an unheated location (e.g. a garage), this device can be configured to adequately reduce relative humidity in the safe and drain moisture to the outside sufficient to substantially prevent condensation on gun barrels and other metal objects in the safe. It will be apparent that more than one temperature control/dehumidifying device can be present and operating in a given safe. In such a situation, it will be apparent that to maintain a given environmental condition the power consumption of each device will probably be lower than if one device alone were performing the entire function.

The invention can thus be described as providing a safe, comprising a safe body, enclosing an interior, and having a lockable door. An AC power supply conduit extends from outside the safe to the interior of the safe. A transformer is disposed in the interior, and is configured to convert AC power to low-voltage DC power. A power distribution system is disposed within the safe, and is configured to distribute the low-voltage DC power to DC devices disposed inside the safe. The DC devices can include a low-voltage DC dehumidifying system that is configured to reduce humidity in the interior of the safe to reduce deterioration of items disposed therein.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A integrated power system for a safe, comprising:
a. a safe;
b. a transformer, associated with the safe, configured to convert AC power input to low voltage DC power; and
c. a power distribution system, disposed within the safe, configured to provide low voltage power to DC powered devices inside the safe.

2. A safe in accordance with claim 1, further comprising DC powered devices selected from the group consisting of a light, a heater, a cooler, a dehumidifier, a safe locking mechanism, an alarm device, a sensor, and a clock.

3. A safe in accordance with claim 2, wherein the heater includes an electro-resistively heated rack, configured to conductively heat metal objects in contact therewith to a temperature above a temperature of surrounding ambient air, so as to resist formation of condensation upon the metal objects.

4. A safe in accordance with claim 3, wherein the electro-resistively heated rack comprises a gun rack configured to contact gun barrels.

5. A safe in accordance with claim 3, wherein the electro-resistively heated rack is configured to the heat metal objects in contact therewith to a temperature that is above a dewpoint of the surrounding ambient air.

6. A safe in accordance with claim 2, wherein the DC powered device comprises a cooler that is configured to controllably promote condensation so as to draw water vapor from surrounding ambient air within the safe.

7. A safe in accordance with claim 6, wherein the cooler comprises a thermo-electric cooler configured to transfer heat between two conductive plates, causing one plate to become cold, thereby causing water vapor in the air to condense on the cold plate.

8. A safe in accordance with claim 6, further comprising a drain, associated with the cooler, configured to direct condensation from the cooler to a point outside the safe.

9. A safe in accordance with claim 2, wherein the sensors are selected from the group consisting of temperature sensors and humidity sensors.

10. A safe in accordance with claim 2, wherein the alarm devices are selected from the group consisting of an alarm indicator light and a connection to an external alarm system.

11. A safe in accordance with claim 1, wherein the transformer is configured to convert 110 volts AC into 12 volts DC for powering the low voltage DC devices inside the safe.

12. A safe, comprising:
a. a safe body, enclosing an interior, having a lockable door;
b. an AC power supply conduit;
c. a transformer, associated with the safe, coupled to the AC power conduit, configured to convert AC power to low-voltage DC power; and
d. a power distribution system, disposed within the safe, configured to distribute the low-voltage DC power from the transformer to DC devices disposed inside the safe.

13. A safe in accordance with claim 12, wherein the DC powered devices are selected from the group consisting of lights, a dehumidifying system, a safe locking mechanism, alarm devices, sensors, and a clock.

14. A safe in accordance with claim 13, wherein the dehumidifying system is selected from the group consisting of a heater, a cooler, and an electro-resistively heated rack, configured to conductively heat metal objects in contact therewith.

15. A safe in accordance with claim 14, wherein the cooler comprises a thermo-electric device, configured to transfer heat between two conductive plates and cause one conductive plate to become cold, thereby causing water vapor in the air within the safe to condense on the cold plate, and further comprising a drain, configured to direct condensation from the cooler to a point outside the safe.

16. A safe in accordance with claim 14, wherein the electro-resistively heated rack is configured to the heat metal objects in contact therewith to a temperature that is above a dewpoint of the surrounding ambient air, so as to resist condensation upon the metal objects.

17. A safe, comprising:
a. a safe body, enclosing an interior, having a lockable door;
b. an AC power supply conduit, extending from an exterior of the safe body to the interior thereof;
c. a transformer, disposed in the interior, configured to convert AC power to low-voltage DC power;
d. a power distribution system, disposed within the safe, configured to distribute the low-voltage DC power within the safe; and
e. a low-voltage DC dehumidifying system, disposed within the safe and interconnected to the power distribution system, configured to reduce humidity in the interior of the safe to reduce deterioration of items disposed therein.

18. A safe in accordance with claim 17, wherein the dehumidifying system is selected from the group consisting of a heater, a cooler, and an electro-resistively heated rack, configured to conductively heat metal objects in contact therewith.
